(19) United States
(12) Patent Application Publication
(10) Pub. No.: US 2008/0005906 A1
(43) Pub. Date: Jan. 10, 2008

(54) Electric Hair Trimmer

(76) Inventors: Wolfgang Franke, Langen (DE); Jurgen Behrendt, Niederbrechen (DE)

Correspondence Address: FISH & RICHARDSON PC, P.O. BOX 1022, MINNEAPOLIS, MN, 55440-1022, US

(21) Appl. No.: 11/777,651

(22) Filed: Jul. 13, 2007

Related U.S. Application Data
(63) Continuation of application No. PCT/EP2006/000158, filed on Jan. 11, 2006.

(30) Foreign Application Priority Data
Jan. 21, 2005 (DE) 10 2005 002 896.9

(51) Int. Cl. B26B 19/12

(52) U.S. Cl. 30/43.7

(57) ABSTRACT

An electric hair trimmer, in particular an electric razor, features a hair trimmer that includes at least one shaving system having an outer cutter and an undercutter, said cutters cooperating in order to cut off hairs. The outer cutter has at least one inner surface that is adjacent to the undercutter, at least one outer surface provided for contact with the skin, and at least one lateral surface that extends between the contours of the inner surface and the outer surface. The lateral surface and the outer surface of the outer cutter define an at least partially acute-angled first edge.

### RELATED APPLICATIONS

This application is a continuation of, and claims priority under 35 U.S.C. 120 from, International Application No. PCT/EP2006/000158, filed Jan. 11, 2006, which claimed priority under 35 U.S.C. 119(a) from German Patent Application DE 10 2005 002896.9, filed Jan. 21, 2005. Both priority applications are incorporated herein in their entirety.

### TECHNICAL FIELD

This invention relates to an electric hair trimmer, in particular an electric razor, and to a shaving system for an electric hair trimmer, in particular for an electric razor.

### BACKGROUND

Very good shaving results can be achieved with electric razors if the beard stubble to be shaved is not too long and stands nearly perpendicular to the skin. Particularly well suited for a thorough shave are short-hair shaving systems which have at least one perforated shaving foil and an undercutter cooperating therewith. A thorough shave is greatly impeded, however, if there are also long hairs in addition to the beard stubble. In the case of these long hairs, there is relatively little probability of them penetrating the perforated shaving foil and then being cut off by the undercutter. For this reason, shaving foil systems are often combined with long hair cutters which pre-shorten the hairs to a length suitable for the shaving foils.

An electric razor with several shaving systems is known from EP 0 914 235 B1 and EP 0 923 430 B1, for example. EP 0 914 235 B1 discloses a dry razor which has a first shaving system with a first outer cutter and a first undercutter mounted for relative movement in between, and a second shaving system with a second outer cutter and a second undercutter mounted for oscillatory motion underneath. The first outer cutter is mounted for oscillatory motion and serves as a skin vibration part. In this case the first outer cutter is driven with the same frequency as the second undercutter. It is also possible for the first outer cutter to cause the skin to vibrate under another of the shaving systems.

From EP 0 923 430 B1, there is also known a dry razor with a first and a second shaving system. All the cutters of the first shaving system are driven such that they cut and cause skin vibrations. The outer cutter of at least one other shaving system is inactive by contrast. Similarly it is also possible for the outer cutter of the first shaving system to be moved in oscillatory fashion, thus serving as a skin vibration part, and for the outer cutter of the second shaving system to be inactive.

By these means, the shaving results can be significantly improved with regard to any long hairs that are present. Under adverse conditions it is possible, however, for long hairs lying close to the skin not to be caught by the shaving systems and hence not to be cut off.

### SUMMARY

The present invention describes an electric hair trimmer that allows hair lying close to the skin to be caught and cut off with good reliability.

According to one aspect of the invention, an electric hair trimmer is constructed in particular as an electric razor and has at least one shaving system with an outer cutter and an undercutter. The outer cutter and the undercutter cooperate in order to cut off hairs. The outer cutter has at least one inner surface that is adjacent to the undercutter, at least one outer surface provided for contact with the skin, and at least one lateral surface that extends between the contours of the inner surface and the outer surface. The lateral surface and the outer surface of the outer cutter define an at least partially acute-angled first edge.

This enables hair to be shortened reliably and thoroughly, whereby in particular there is great probability of even hair lying close to the skin being lifted and cut off. Hence it suffices for the hair trimmer to be passed only once or a few times over the same area of skin in order to shorten the hair thoroughly, thus reducing the time required on the whole for shortening the hair.

The outer surface of the outer cutter may be a plane, and the first edge may have an edge angle along the first edge, at least part of which is smaller than about 80°, and preferably is between about 40° and about 60°. In this angle range, it is possible to shorten the hair thoroughly with little risk of causing skin irritations or skin injuries.

In a further aspect of the invention, the outer surface of the outer cutter has a three-dimensional structure. This enables the surface of the skin to be deformed locally, thereby increasing still further the efficiency of the hair shortening in particular with regard to hairs lying close to the skin. In this aspect it is particularly advantageous for the outer surface of the outer cutter to have an undulating construction. The further aspect with a three-dimensionally structured outer surface is preferably constructed such that the lateral surface of the outer cutter and a plane surface tangent to the outer surface of the outer cutter in the region of the first edge include an angle between them, at least part of which is smaller than about 80°, and preferably is between about 40° and about 60°. The fictive plane surface serves solely to define the angle with regard to the three-dimensional structure of the outer surface.

The lateral surface and the inner surface of the outer cutter may form an at least partially acute-angled second edge, which preferably has an edge angle of between 40° and 60°. The acute-angled construction of the second edge reduces the cutting forces.

In a preferred embodiment, a fillet is formed on the lateral surface of the outer cutter. A fillet can be produced relatively easily, for example by etching, and enables a particularly reliable lifting of hairs lying close to the skin. The fillet may extend as far as the outer surface of the outer cutter and preferably also as far as the inner surface of the outer cutter.

The outer cutter is constructed preferably as a comb having a plurality of teeth arranged parallel to the inner surface. In this arrangement the teeth may be constructed in particular by a wave-shaped contour of the outer cutter. An outer cutter constructed in this way promotes the threading in of the hairs and is mechanically stable. Moreover, the outer cutter and/or the undercutter may have a U-shaped cross-section. In this way, it is possible to obtain sufficient stability and make the shaving system very compact. Within the scope of the invention, it is possible for the outer cutter and/or the undercutter to be movable and to execute in particular a linear oscillating movement. In this case, it is an advantage, for example, in order to achieve a high cutting speed and to reduce vibrations, for the outer cutter and the undercutter to be drivable in phase opposition to each other.

Provision can be made on the hair trimmer of the invention for stationary pressure elements which project beyond the outer surface of the outer cutter. With the aid of these pressure elements, it is possible to prevent the skin from following the movements of the outer cutter. A particularly compact construction can be accomplished if the pressure elements are integrated in the structure of the outer cutter, thus requiring no or only little additional space.

Preferably provision is made on the hair trimmer of the invention for at least one additional shaving system which is constructed as a short-hair shaving system, in particular as a shaving foil system. Thorough shortening of the hair very close to the skin is thus possible.

Still further, the invention relates to a shaving system for an electric hair trimmer, in particular for an electric razor, having an outer cutter and an undercutter which cooperate to cut off hairs. The outer cutter has at least one inner surface that is adjacent to the undercutter, at least one outer surface provided for contact with the skin, and at least one lateral surface that extends between the contours of the inner surface and the outer surface. The lateral surface and the outer surface of the outer cutter define an acute angle.

### DESCRIPTION OF DRAWINGS

The present invention will be explained in more detail in the following with reference to the embodiments illustrated in the accompanying drawings.

FIG. 1 is a sectional view of a shaving head in an electric razor having a long-hair cutter;

FIG. 2 is a perspective view of a long-hair cutter;

FIG. 3 is a sectional view of the long-hair cutter of FIG. 2;

FIG. 4 is a view of an enlarged detail of FIG. 2; and

FIG. 5 is a side view of the detail shown in FIG. 4.

Like reference symbols in the various drawings indicate like elements.

### DETAILED DESCRIPTION

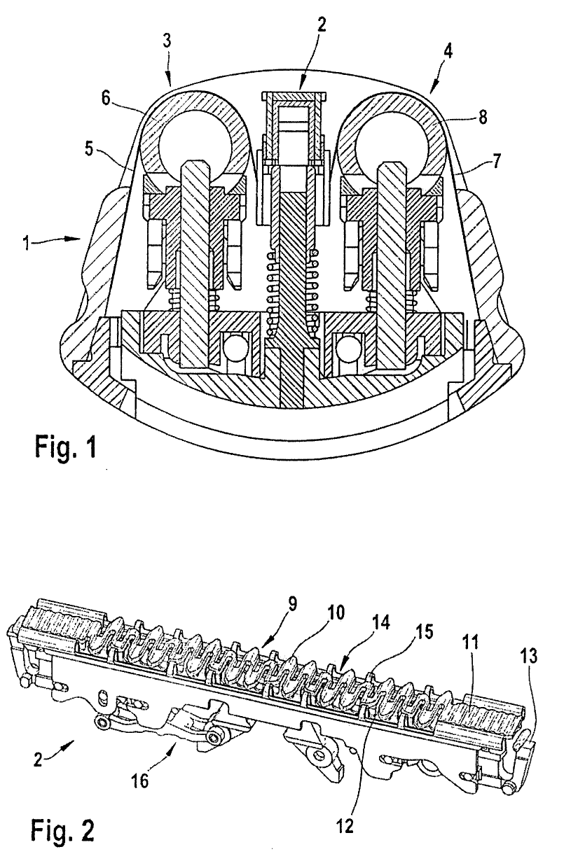

FIG. 1 shows a sectional representation of an embodiment of a shaving head 1 in an electric razor 100 with a long-hair cutter 2. The long-hair cutter 2 is arranged laterally between a first shaving foil system 3 and a second shaving foil system 4. The first shaving foil system 3 has a first shaving foil 5 and a first blade support 6, and the second shaving foil system 4 has a second shaving foil 7 and a second blade support 8. The long-hair cutter 2 is used for pre-shortening the hairs, thus making it easier for them to thread into the apertures of the perforated shaving foils 5 and 7.

Similarly, the long-hair cutter 2 could also be used on a shaving head 1 with a different number of shaving foil systems 3 and 4 or with different shaving systems than the shaving foil systems 3 and 4. For example, the long-hair cutter 2 could be arranged laterally alongside a single shaving foil system 3 or 4 of the shaving head 1. Furthermore, the long-hair cutter 2 could also be used without an additional shaving foil system 3 or 4 on an electric beard trimmer or an electric hair trimmer.

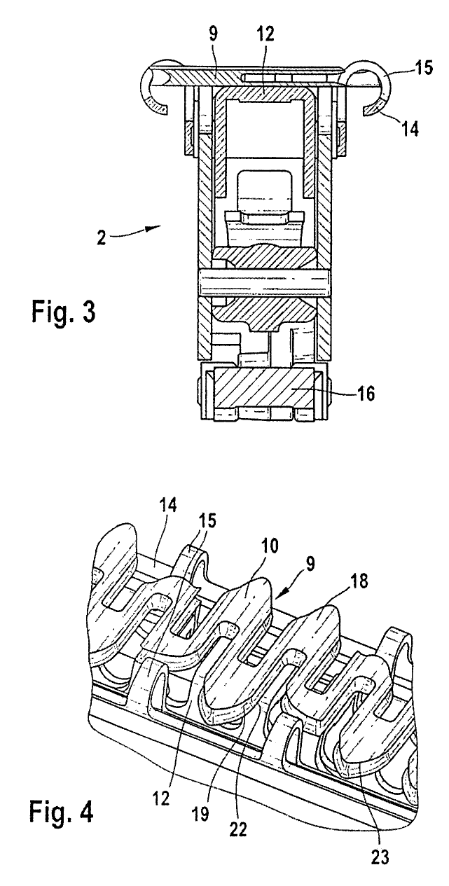

FIG. 2 shows in a perspective representation of a long-hair cutter 2. A related cross-sectional view through the long-hair cutter 2 is shown in FIG. 3. The long-hair cutter 2 has a wave-shaped comb 9 with a plurality of teeth 10 tapering to a pointed end. In two end regions 11 the comb 9 has no teeth 10 but is of plane construction. In its cross-section, the comb 9 is of a U-shaped configuration, for which purpose it may be welded together, for example, from three parts. Arranged in the interior space of the comb 9 is a blade 12 with multiple transverse slots and a likewise U-shaped cross-section, said blade resting resiliently against the teeth 10 of the comb 9. Using two plastic retaining arms 13, which are arranged on the opposite narrow sides of the long-hair cutter 2, the long-hair cutter 2 can be fixed in its installation environment, for example in the shaving head 1 shown in FIG. 1. The two retaining arms 13 are connected together by means of two pressure bars 14 which extend along the longitudinal sides of the long-hair cutter 2. The pressure bars 14 have several pressure elements 15 which are spaced apart from each other along the longitudinal direction of the pressure bars 14 and project beyond the comb 9. The comb 9 and the blade 12 can be driven by way of a lever mechanism 16.

Preferably the comb 9 and the blade 12 are set in linear oscillating movements of identical frequency in phase opposition to each other parallel to their longitudinal direction, with the comb 9 oscillating typically with an amplitude of about 0.2 mm. Alternatively, it is also possible for only the comb 9 or only the blade 12 to be driven. The oscillatory motion of the comb 9 supports the lifting of hairs lying close to the skin when the long-hair cutter 2 is passed over the skin, with the comb 9 being in engagement with the skin. As this occurs, the skin is fixed by the pressure elements 15 in order to prevent it from following the movement of the comb 9. The lifted hairs and the hairs already standing off the skin are guided between the teeth 10 of the comb 9, are fed to the blade 12 through multiple slots between the teeth in the comb, and cut off in the area of contact between the blade 12 and the comb 9.

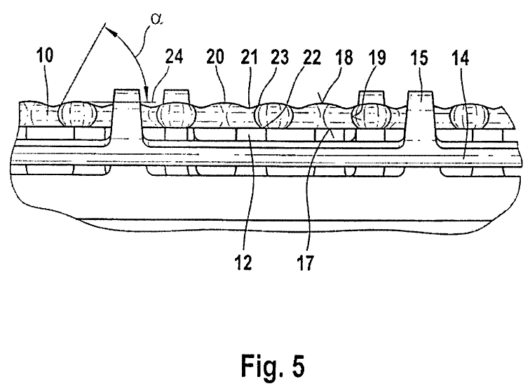

The lifting of the hairs is supported in addition by the shape of the comb 9. This will be explained below in more detail with reference to FIG. 4 and FIG. 5.

FIG. 4 shows an enlarged detail of FIG. 2. A related side view of this detail is shown in FIG. 5. The outer shape of the comb 9 is of importance for the invention and is defined by an inner surface 17, an outer surface 18, and a lateral surface 19. Depending on the geometry of the comb 9, it is also possible for the surfaces 17, 18, and 19 to be constructed as non-interconnected and, accordingly, for there to be several inner surfaces 17, outer surfaces 18, and lateral surfaces 19. The inner surface 17 of the comb 9 is a plane and serves as an engagement surface for the blade 12. The outer surface 18 of the comb 9 is essentially congruent with the inner surface 17, and engages the skin during the shaving operation. Unlike the inner surface 17, however, the outer surface 18 is not a plane surface, but has an undulating surface topography. In particular this undulation is constructed such that elevations 20 and depressions 21 follow each other periodically along the longitudinal direction of the comb 9, and there is no modulation of the surface transverse to this direction. The lateral surface 19 of the comb 9 extends between the inner surface 17 and the outer surface 18 and combines with the inner surface 17 to form a cutting edge 22, and with the outer surface 18 to form an outer edge 23.

Formed on the lateral surface 19 of the comb 9 is a fillet such that the lateral surface 19 is concave in shape. This means in turn that the outer edge 23 of the comb 9 is acute-angled, meaning that it has an edge angle which is smaller than 90°. Furthermore, the lateral surface 19 includes, together with a plane surface 24 tangent to the outer surface 18 in the region of the outer edge 23, an angle α which is smaller than 90°, so that the angle α is likewise an acute angle. This means that, during shaving, a partial area of the lateral surface 19 close to the skin includes an acute angle with the skin surface. This facilitates the lifting of hairs lying close to the skin surface by the comb 9, and hence increases the chances of such hairs being fed to the blade 12 for severing. This process is supported by the undulating shape of the outer surface 18 of the comb 9, as said surface leads to a local deformation of the skin surface, which can result in particular in the distance between the end region of the respective hair and the skin surface being enlarged.

In principle, the smaller the angle α, the more reliably the hairs will be lifted from the skin surface by the combing action of the comb 9. However, as the size of the angle α decreases, so the risk of skin injuries or skin irritations increases, which means that very small values for the angle α are not desirable. The risk of injury can be reduced by rounding off the outer edge 23 of the comb 9. However, the edge radius must not be too large as the lifting effect by the comb decreases as the edge radius increases. To obtain meaningful values with a rounded outer edge 23, the angle α is determined outside the rounding, but as close as possible to the outer surface 18 of the comb 9. Preferably, values below about 80° are used for the angle α, with a range of between about 40° and about 60° representing a good compromise between lifting effect and risk of injury.

The fillet on the lateral surface 19 of the comb 9 results furthermore in the cutting edge 22 being acute-angled, meaning that the cutting angle is smaller than 90°. Given a symmetrical construction and location of the fillet between the inner surface 17 and the outer surface 18 of the comb 9, the cutting angle has substantially the same value as the angle α. The acute-angled construction of the cutting edge 22 results in a reduction of the cutting forces compared to a rectangular construction. In this arrangement, good results can be achieved with the same values as for the angle α, that is, with cutting angles of between about 40° and about 60°. However, contrary to the outer edge 23, the cutting edge 22 is not rounded or only minimally rounded.

In particular, in combination with further shaving systems such as the shaving foil system 3 or 4, there is only limited space available for the long-hair cutter 2, hence a compact construction of the long-hair cutter 2 is desirable. However, minimizing the lateral dimensions of the long-hair cutter 2 entails risking a collision between the linearly oscillating comb 9 and the stationary pressure elements 15. As becomes apparent in particular from FIG. 4, it is nevertheless possible for the pressure elements 15 to be largely integrated in the space of the comb 9 so that the lateral dimensions of the long-hair cutter 2 are increased only slightly by the pressure elements 15. For this purpose, the respective tooth 10 of the comb 9, which would collide with one of the pressure elements 15, is reduced in its dimensions to the point where there is no longer any threat of a collision. As the number of teeth 10 is appreciably greater than the number of pressure elements 15, and the hairs are also fed to a certain degree by the pressure elements 15 to the blade 12, reducing the lateral dimensions of some teeth 10 is, as a rule, justifiable.

In a modification, the outer surface 18 of the comb 9 is of a plane configuration. Furthermore, the system could be modified such that the lateral surface 19 of the comb 9 has, instead of the fillet, a different shape that results in an acute-angled outer edge 23. This shape could be created by rectilinear and/or curvilinear sections.

A number of embodiments of the invention have been described. Nevertheless, it will be understood that various modifications may be made without departing from the spirit and scope of the invention. Accordingly, other embodiments are within the scope of the following claims.

What is claimed is:

1. An electric hair trimmer comprising a shaving system, the shaving system comprising:
an undercutter; and
an outer cutter that cooperates with the undercutter to cut hair, the outer cutter comprising:
an inner surface adjacent to the undercutter;
an outer surface arranged to contact skin; and
a lateral surface that extends between a contour of the inner surface and a contour of the outer surface, wherein the lateral surface and the outer surface of the outer cutter define therebetween an at least partially acute-angled first edge.

2. The hair trimmer of claim 1, wherein at least a portion of the edge defines an angle of less than about 80°.

3. The hair trimmer of claim 2, wherein the angle is in a range between about 40° and about 60°.

4. The hair trimmer of claim 1, wherein the outer surface of the outer cutter has a three-dimensional structure.

5. The hair trimmer of claim 4, wherein the outer surface of the outer cutter has an undulating construction.

6. The hair trimmer of claim 5, wherein the lateral surface of the outer cutter and a plane surface tangent to the outer surface of the outer cutter in a region of the first edge define an angle less than about 80° along at least a portion of the first edge.

7. The hair trimmer of claim 6, wherein the angle along at least the portion of the first edge is in a range between about 40° and about 60°.

8. The hair trimmer of claim 1, wherein the lateral surface of the outer cutter and the inner surface of the outer cutter form an at least partially acute-angled second edge.

9. The hair trimmer of claim 8, wherein the at least partially acute-angled second edge is in a range between about 40° and about 60°.

10. The hair trimmer of claim 1, wherein the lateral surface of the outer cutter defines a fillet.

11. The hair trimmer of claim 10, wherein the fillet extends from the outer surface of the outer cutter to the inner surface of the outer cutter.

12. The hair trimmer of claim 1, wherein the outer cutter comprises a comb having a plurality of teeth substantially parallel to the inner surface of the outer cutter.

13. The hair trimmer of claim 12, wherein the teeth are constructed by a wave-shaped contour of the outer cutter.

14. The hair trimmer of claim 1, wherein the outer cutter has a U-shaped cross section.

15. The hair trimmer of claim 1, wherein the undercutter has a U-shaped cross section.

16. The hair trimmer of claim 1, wherein the outer cutter is configured to move relative to the hair trimmer.

17. The hair trimmer of claim 16, wherein the outer cutter is configured to move in a linear oscillating motion.

18. The hair trimmer of claim 1, wherein the undercutter is configured to move relative to the hair trimmer.

19. The hair trimmer of claim 18, wherein the undercutter is configured to move in a linear oscillating motion.

20. The hair trimmer of claim 1, wherein the outer cutter and the undercutter are drivable in phase opposition to each other.

21. The hair trimmer of claim 1, further comprising stationary pressure elements that project beyond the outer surface of the outer cutter.

22. The hair trimmer of claim 1, wherein the outer cutter further comprises pressure elements.

23. The hair trimmer of claim 1, further comprising an additional shaving system, wherein the additional shaving system is a shaving foil system.

24. A shaving system comprising:
an undercutter; and
an outer cutter that cooperates with the undercutter to cut hair, the outer cutter comprising:
an inner surface adjacent to the undercutter;
an outer surface arranged to contact skin; and
a lateral surface that extends between a contour of the inner surface and a contour of the outer surface, wherein the lateral surface and the outer surface of the outer cutter define therebetween an at least partially acute-angled first edge.
